(19) United States
(12) Patent Application Publication
(10) Pub. No.: US 2013/0325260 A1
(43) Pub. Date: Dec. 5, 2013

(54) VEHICLE DRIVING GUIDING DEVICE AND METHOD

(71) Applicant: HYUNDAI MOTOR COMPANY, Seoul (KR)

(72) Inventors: Hyun Kim, Hwaseong-si (KR); Hee Sang Park, Hwaseong-si (KR); Jun Kyu Park, Hwaseong-si (KR); Jun Mo Ku, Hwaseong-si (KR)

(73) Assignee: Hyundai Motor Company, Seoul (KR)

(21) Appl. No.: 13/692,682

(22) Filed: Dec. 3, 2012

(30) Foreign Application Priority Data
Jun. 4, 2012 (KR) 10-2012-0059595

(51) Int. Cl. G01C 21/36

(52) U.S. Cl. CPC G01C 21/3626
USPC 701/36

(57) ABSTRACT

A vehicle driving guiding device includes a plural of light emitting sections each that is provided, respectively, inside plural grills of air-vents which are arranged in front side of interior space of the vehicle and emits light to the interior space of the vehicle through the grills of the air-vents, and a controller for controlling a left-light emitting section provided on a left side of the light emitting section to emit light in case of a left direction indication signal and for controlling a right-light emitting section provided on a right side of the light emitting section to emit light in case of a right direction indication signal when road guiding direction indication signal is produced. A method is also described.

### CROSS-REFERENCE TO RELATED APPLICATION

The present application claims priority of Korean Patent Application Number 10-2012-0059595 filed Jun. 4, 2012, the entire contents of which application is incorporated herein for all purposes by this reference.

### BACKGROUND OF INVENTION

1. Field of Invention

The present disclosure relates to a vehicle driving guiding device and a method through which when a road guiding direction indication signal for guiding a road is produced, a light-emitting section of the corresponding direction is light-emitted, and thus visibility effect is improved and convenient and safe driving is ensured.

2. Description of Related Art

Generally, a vehicle driving guiding device may supply in real time the location information that is received from GPS satellite to a driver, and establish traffic information and map information, and display and guide a route to a desired destination for the driver. A representative example of the vehicle driving guiding device is a navigator wherein it provides driving information, displays and guides a optimal route to a destination through a complex type of image and voice.

Meanwhile, according to a prior vehicle driving guiding device, a system for providing in advance the direction indication signal to a driver has been used generally in which in case of changing a traveling direction, not only a direction indication signal is displayed in advance on a picture and but also voice guiding is provided.

However, in case where the direction indication signal is displayed and voice guiding message is provided in the vehicle driving guiding device while a driver listens to radio and music, radio and music is interrupted or voice amount is decreased due to the voice guiding message from the vehicle driving guiding device. At this time, a driver is interrupted to listen to radio and music due to the voice guiding message and thus in case of eliminating the voice in a vehicle driving guiding device and driving a vehicle, the driver cannot follow the direction indication signal and may leave the route.

In order to solve the above drawbacks, even though the driving guiding information including a vehicle driving speed and various information are provided on a cluster, visibility is not ensured sufficiently and a driving concentration of a driver is to be diffused.

Further, even though the driving guiding information is provided by using a Head Up Display (HUD) system, the HUD system costs high and further a size of an icon indicating the direction indication signal is limited.

Additionally, the direction indicating signal is displayed on a vehicle room mirror, however, visibility is not ensured sufficiently and further recognition of a driver is decreased due to short distance and long distance focal point variations.

The driving guiding system as described above is unsafe since it has a limitation to ensure visibility and further driving concentration is diffused, and thus an inadvertent driving is leaded while a driver observes the driving guiding information to cause accident.

Accordingly, in order for a driver to recognize surely the direction indication signal provided through the vehicle driving guiding device, there needs a technology that improves visibility effect and prevents fundamentally the driving concentration diffusion.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to solve the above-described problems associated with prior art. Various aspects of the present invention provide for a vehicle driving guiding device and a method thereof in which a light emitting section is provided for a driver to recognize surely the direction indication signal provided through the vehicle driving guiding device thereby improving visibility effect and preventing fundamentally the driving concentration diffusion.

Various aspects of the present invention provide for a vehicle driving guiding device including a plural of light emitting sections each that is provided, respectively, inside plural grills of air-vents which are arranged in front side of interior space of the vehicle and emits light to the interior space of the vehicle through the grills of the air-vents, and a controller for controlling a left-light emitting section provided on a left side of the light emitting section to emit light in case of a left direction indication signal and for controlling a right-light emitting section provided on a right side of the light emitting section to emit light in case of a right direction indication signal when road guiding direction indication signal is produced.

The plural of light emitting sections each may be provided inside the grills of the air vents provided on the left and right sides, respectively, of a driver's seat.

The plural light emitting sections each may be provided inside the grills of the air-vents arranged on the left and right sides of a center fascia of a vehicle.

The plural light emitting sections each may be provided leftward and rightward, respectively, inside the grills of the defrost air-vents of a vehicle.

The controller may control brightness of the light emitting section depending on external luminance.

The controller may receive a road guiding direction indication signal from a navigator.

The controller may control the light emitting section to emit light in case where the navigator is in ON state and voice eliminated-state when the road guiding direction indication signal is produced.

Various aspects of the present invention provide for a vehicle driving guiding method including the steps checking whether a road guiding direction indication signal is produced, determining whether the road guiding direction indication signal is a left direction indication signal or a right direction indication signal, and controlling a plural light emitting sections provided inside the grills of the air-vents to emit light wherein a left-light emitting section is controlled when the road guiding direction indication signal is a left direction indication signal and a right-light emitting section is controlled when the road guiding direction indication signal is a right direction indication signal.

The method may further include the steps confirming whether the navigator is in ON state, and voice-confirming whether the navigator is in a voice-eliminated state wherein the controller controls the light emitting section when the navigator is in ON state and voice-eliminated state.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view showing a configuration of an exemplary vehicle driving guiding device according to the present invention.

FIG. 2 is a view showing a light emitting section provided inside grills of air-vents in the vehicle driving guiding device as shown in FIG. 1.

FIG. 3 is a view showing the grills of the air-vents in which the light emitting section of the vehicle driving guiding device as shown in FIG. 1 is provided.

FIG. 4 is a flow chart showing an exemplary vehicle driving guiding method according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

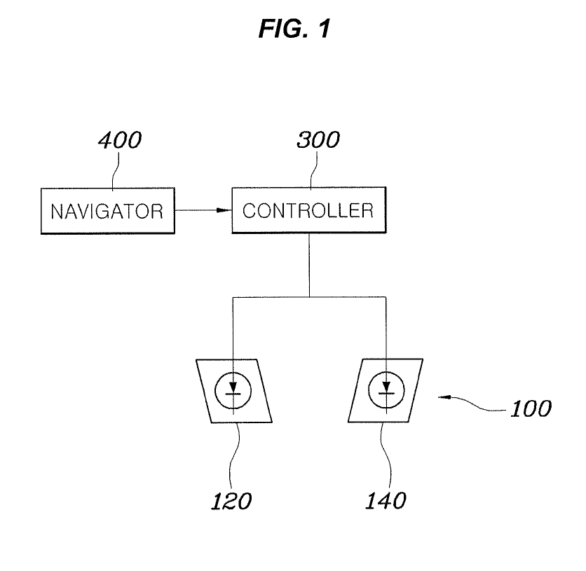

FIG. 1 is a view showing a configuration of a vehicle driving guiding device according to various embodiments of the present invention wherein the vehicle driving guiding device includes a plural light emitting sections each 100 that is provided inside grills of a plurality of air-vents 200 which are provided in front part of an interior space of a vehicle and discharges conditioned-air, and emits light to the interior space through the grills of the air-vents 200, and controller 300 for controlling the light emitting section 100 to emit light such that a left-light emitting section 120 provided on a left side of the light emitting section is operated when a left direction indication signal of the road guiding direction signal is produced and a right-light emitting section 140 provided on a right side of the light emitting section is operated when a right direction indication signal of the road guiding direction signal is produced.

The air-vents 200 provided on a front part of the interior space of a vehicle includes a side air-vents, a center air-vents and a defrost air-vents wherein it is disposed at a place where a driver can recognize the light passing through the grills of the air-vents 200 when the light emitting section 100 provided inside the grills of the air-vents 200 emits light.

Here, the left-light emitting section 120 and the right-light emitting section 140 of the light emitting section 100 may be provided inside the grills of the air-vents 200, respectively. This is because that the present invention intends only for a driver to recognize by operating the light emitting section 100 in case where the road guiding direction indication signal is produced that fact that the direction indication signal is produced and to follow the direction indicated-route without observing the vehicle driving guiding device.

Accordingly, the left-light emitting section 120 and the right-light emitting section 140 are provided, respectively, in the inner part of the grills that is distinguished between a left side and a right side and thus a driver can follow a target route to increase visibility and recognize surely the direction indication signal.

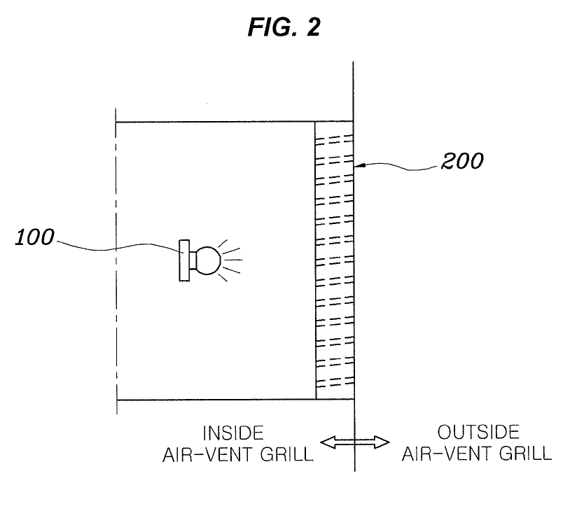

FIG. 2 is a view showing a light emitting section 100 provided inside grills of air-vents 200 in the vehicle driving guiding device as shown in FIG. 1 wherein the interior part of the grills of the air-vents 200 in which the light emitting section is arranged serves as a dark chamber since light is shielded at day times thereby increasing visibility. Here, en electric bulb or LED may be used as the light emitting section 100 and further the light emitting section is provided inside the grills of the air-vents 200 for flow resistance of the conditioned-air to be minimized.

Through the light emitting from the light emitting section 100 when the road guiding indication signal is produced from the road guiding device, a driver can recognize the road guiding signal and follow the direction indicated-route and further the light emitting section 100 is provided inside the grills of the air-vents 200 and thus outer appearance of a vehicle is configured fundamentally to be good without any limitation to interior design of a vehicle.

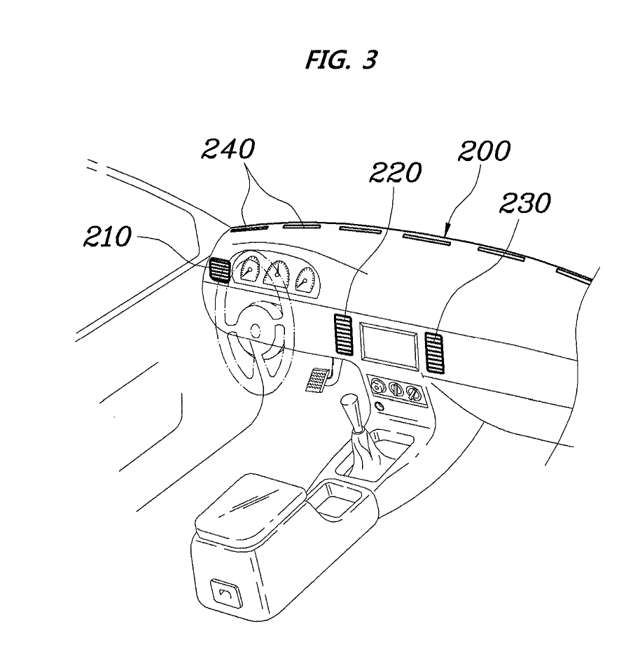

In more detailed description of a location of the air-vents 200 in which the light emitting section 100 is provided, FIG. 3 is a view showing the grills of the air-vents 200 in which the light emitting section 100 of the vehicle driving guiding device as shown in FIG. 1 is provided wherein the light emitting section 100 is provided inside the grills of the air-vents 210, 220 arranged on the left and right sides, respectively, of a driver's seat.

When the light emitting section 100 is provided inside the grills of the air-vents 210, 220 provided on the left and right sides of a driver's seat, a driver can recognize surely the left and right directions of the direction indication signal and ensure visibility.

Further, the light emitting section 100 is provided inside the grills of the air-vents 220, 230 arranged on the left and right sides of a center fascia of a vehicle. This configuration may be preferable when the driving guiding device is buried into the center fascia or is provided on a middle of a vehicle. As a result, a direction indication can be made through the light emitting section 100 when the road guiding direction indication signal is produced, and further a driver can recognize the vehicle driving guiding device provided on the center fascia side and confirm easily the driving information.

Additionally, the light emitting section 100 may be provided inside the grills of the defrost air-vents 240 of a vehicle on the left and right sides thereof. Specially, the light emitting section 100 is provided inside the grills of the defrost air-vents 240 wherein the left-light emitting section 120 and the right-light emitting section 140 are arranged at an interval to be distinguished. At this time, the light emitting section 100 provided inside the grills of the defrost air-vents 240 may be arranged on fronts of a driver's seat and a passenger's seat, or may be arranged on a front of a driver's seat as plural.

Generally, since a driver observes a front side of a vehicle while he/she drives a vehicle, the driver can ensure visibility easily when the light emitting section 100 is provided inside the grills of the defrost air-vents 240.

Meanwhile, the controller 300 can control brightness of the light from the light emitting section 100 depending on external luminance. Generally, since the luminance of sunlight is different depending on day and night, the brightness of the light from the light emitting section 100 is controlled for visibility not to be decreased due to brightness variation.

Here, the external luminance is measured by an outdoor luminance sensor or indoor luminance sensor and when the luminance is low, the brightness of the light from the light emitting section 100 may be controlled to be low, and when the luminance is high, the brightness of the light from the light emitting section 100 may be controlled to be high.

Meanwhile, the controller 300 receives the road guiding direction indication signal from a navigator 400. Here, the controller 300 may control the light emitting section 100 to emit light when the controller receives the road guiding direction indication signal through the navigator 400 and further the navigator 400 is in ON state and voice eliminated-state.

Of course, even if the navigator 400 is not in voice eliminated-state, the controller may control permissibly the light emitting section 100 to emit light depending on the direction indication signal, and further the vehicle driving guiding device may provide minimum means for a driver to recognize the direction indication signal since the present invention intends to prevent a driver from not recognizing the road guiding direction indication signal and being left from a route.

That is, even in situation where a driver can recognize the voice from the navigator 400, electric energy is unnecessarily consumed through unnecessary control of the light emitting section 100 and thus the light emitting section 100 may be controlled for a driver to recognize the direction indication signal in case where the voice is eliminated in the navigator 400.

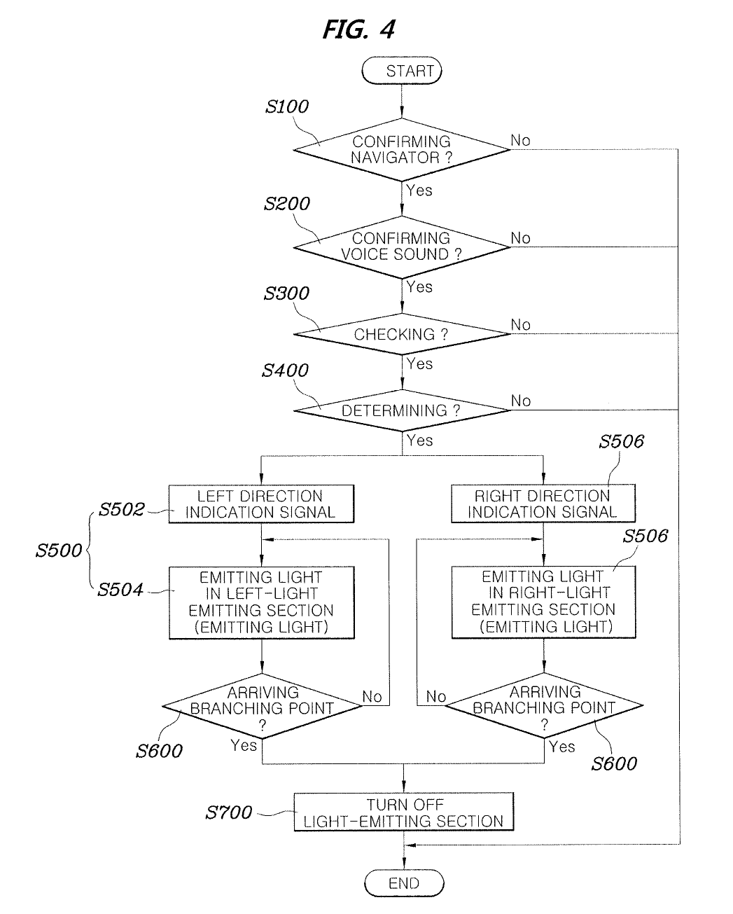

Meanwhile, FIG. 4 is a flow chart showing a vehicle driving guiding method according to various embodiments of the present invention wherein it includes steps of checking whether the road guiding direction signal is produced S300, determining whether the road guiding direction signal is a left direction signal or a right direction signal S400, and controlling the light emitting section provided inside the grills of the air-vents as plural S500 to emit light such that when the road guiding direction indication signal is a left direction indication signal, the left-light emitting section is controlled, and when the road guiding direction indication signal is a right direction indication signal, the right-light emitting section is controlled.

By using this vehicle driving guiding method, the light emitting section is operated to emit light when the road guiding direction indication signal is produced for a driver to recognize the fact that the direction indication signal is produced and to follow the direction indicated-route without observing the vehicle driving guiding device.

Accordingly, the light emitting section is provided inside the grills of the air-vents that is distinguished between a left and right sides, respectively, and thus a driver is guided to drive on a target route and further visibility is improved thereby confirming surely the direction indication signal.

Meanwhile, the vehicle driving guiding method according to various embodiments of the present invention further includes steps of confirming whether the navigator is in ON state S100, and confirming voice volume whether the voice is eliminated in the navigator S200 wherein the light emitting section is controlled to emit light when the navigator is in ON state and the voice in the navigator is eliminated.

Of course, even if the voice is not eliminated in a navigator, the light emitting section is controlled to emit light, however, the driving guiding device may provide minimum means for a driver to recognize the direction indication signal since the present invention intends to prevent a driver from not recognizing the road guiding direction indication signal and being left from a route.

That is, even in situation where a driver can recognize the voice from the navigator, electric energy is unnecessarily consumed through unnecessary control of the light emitting section 100 and thus the light emitting section may be controlled in case where the voice is eliminated in the navigator.

For convenience in explanation and accurate definition in the appended claims, the terms front, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A vehicle driving guiding device, comprising:
a plural of light emitting sections each provided, respectively, inside plural grills of air-vents which are arranged in front side of interior space of the vehicle and emits light to the interior space of the vehicle through the grills of the air-vents; and
a controller for controlling a left-light emitting section provided on a left side of the light emitting section to emit light in case of a left direction indication signal and for controlling a right-light emitting section provided on a right side of the light emitting section to emit light in case of a right direction indication signal when road guiding direction indication signal is produced.

2. The vehicle driving guiding device of claim 1, wherein each of the plural of light emitting sections is provided inside the grills of the air vents provided on the left and right sides, respectively, of a driver's seat.

3. The vehicle driving guiding device of claim 1, wherein each of the plural light emitting sections is provided inside the grills of the air-vents arranged on the left and right sides of a center fascia of a vehicle.

4. The vehicle driving guiding device of claim 1, wherein each of the plural light emitting sections is provided leftward and rightward, respectively, inside the grills of the defrost air-vents of a vehicle.

5. The vehicle driving guiding device of claim 1, wherein the controller controls brightness of the light emitting section depending on external luminance.

6. The vehicle driving guiding device of claim 1, wherein the controller receives a road guiding direction indication signal from a navigator.

7. The vehicle driving guiding device of claim 6, wherein the controller controls the light emitting section to emit light when the navigator is in ON state and voice eliminated-state when the road guiding direction indication signal is produced.

8. A vehicle driving guiding method, comprising the steps of:
checking whether a road guiding direction indication signal is produced;
determining whether the road guiding direction indication signal is a left direction indication signal or a right direction indication signal; and
controlling a plural light emitting sections provided inside the grills of the air-vents to emit light wherein a left-light emitting section is controlled when the road guiding direction indication signal is a left direction indication signal and a right-light emitting section is controlled when the road guiding direction indication signal is a right direction indication signal.

9. The vehicle driving guiding method of claim 8, further comprising the steps of: confirming whether the navigator is in ON state; and voice-confirming whether the navigator is in a voice-eliminated state wherein the controller controls the light emitting section when the navigator is in ON state and voice-eliminated state.
